(19) United States
(12) Patent Application Publication
(10) Pub. No.: US 2026/0118291 A1
(43) Pub. Date: Apr. 30, 2026

(54) SAMPLE LOADING SYSTEM FOR A RADIATION EFFECTS TESTING SYSTEM

(71) Applicant: SHINE Technologies, LLC, Janesville, WI (US)

(72) Inventors: Scott Biba, Waunakee, WI (US); Mike Philipps, Stoughton, WI (US); Shawn Underhill, Beloit, WI (US)

(21) Appl. No.: 19/366,845

(22) Filed: Oct. 23, 2025

Related U.S. Application Data
(60) Provisional application No. 63/711,460, filed on Oct. 24, 2024.

(51) Int. Cl. G01N 23/2204; G01N 23/222

(52) U.S. Cl. CPC G01N 23/2204; G01N 23/222; G01N 2223/1066

(57) ABSTRACT

A radiation effects testing system that includes a sample test housing, a neutron generator comprising a beam accelerator configured to generate an ion beam, a target chamber, and a beamline extending from the beam accelerator to the target chamber, and a sample loading system comprising a loading duct having a loading end and a chamber end, and a sample carrier translatable along the loading duct. The chamber end is coupled to the sample test housing, thereby providing a pathway from the loading end into the sample test housing. The loading duct comprises a descent segment extending from the loading end and an approach segment extending from the chamber end. The descent segment and the approach segment are non-parallel. Moreover, the sample carrier is in an upright orientation when located in the descent segment of the loading duct and when located in the approach segment of the loading duct.

### RELATED APPLICATIONS

This application claims priority to and the benefit of U.S. Provisional Patent Application No. 63/711,460 filed Oct. 24, 2024, which is incorporated herein by reference in its entirety for all purposes.

### BACKGROUND

The present disclosure is generally directed radiation effects testing systems, such as, for example, radiation effects testing systems that include a neutron generator having a beam accelerator.

### SUMMARY

According to one embodiment of the present disclosure, a radiation effects testing system includes a sample test housing, a neutron generator comprising a beam accelerator configured to generate an ion beam, a target chamber, and a beamline extending from the beam accelerator to the target chamber, and a sample loading system comprising a loading duct having a loading end and a chamber end, and a sample carrier translatable along the loading duct. The chamber end is coupled to the sample test housing, thereby providing a pathway from the loading end into the sample test housing. The loading duct comprises a descent segment extending from the loading end and an approach segment extending from the chamber end. The descent segment and the approach segment are non-parallel. Moreover, the sample carrier is in an upright orientation when located in the descent segment of the loading duct and when located in the approach segment of the loading duct.

In some embodiments, the sample carrier comprises a base, a sidewall, and a top.

In some embodiments, the base comprises a leading base edge comprising a cutout portion configured to face the target chamber of the neutron generator when the sample carrier is positioned in the sample test housing.

In some embodiments, the sample loading system further comprises a drive system configured to translate the sample carrier along the loading duct.

In some embodiments, the sample loading system further comprises a cable feeding system operatively coupled to the drive system and configured to feed cable into the loading duct at a rate corresponding to translation of the sample carrier.

In some embodiments, the cable feeding system comprises: a feeding element configured to guide cable into the loading duct; and a drive linkage coupling the feeding element to the drive system.

In some embodiments, the cable feeding system further comprises a tensioning element configured to maintain tension on the cable; wherein the tensioning element is movable between an engaged position and a disengaged position.

In some embodiments, the cable feeding system is positioned above the loading end of the loading duct.

In some embodiments, a rail system comprising one or more guide tracks is positioned in the loading duct and the sample carrier is configured to travel along the rail system.

In some embodiments, the one or more guide tracks extend outward from the loading end of the loading duct.

In some embodiments, the sample loading system further comprises a drive system comprising a link mechanism coupled to a drive mechanism; the link mechanism is positioned within at least one of the one or more guide tracks and coupled the sample carrier; and the drive mechanism is configured to translate the link mechanism within the at least one guide track thereby translating the sample carrier along the loading duct.

In some embodiments, the system further comprises a cable retainer coupled to the link mechanism and positioned between the drive mechanism and the sample carrier.

In some embodiments, the drive system further comprises: a secondary link mechanism positioned within the secondary guide track and coupled to the sample carrier; and a coupling member connecting the drive mechanism to the secondary link mechanism.

In some embodiments, the drive mechanism is configured to simultaneously translate both the link mechanism and the secondary link mechanism through their respective guide tracks.

In some embodiments, the coupling member comprises a drive plate positioned between the drive mechanism and both link mechanisms, and connecting arms extending from the drive plate to the secondary link mechanism.

In some embodiments, the one or more guide tracks of the rail system comprise a primary guide track and a secondary guide track.

In some embodiments, the sample carrier comprises a base connector coupled to the primary guide track and a roof connector coupled to the secondary guide track.

In some embodiments, the primary guide track extends along a first inner wall of the loading duct and the secondary guide track extends along a second inner wall of the loading duct.

In some embodiments, wherein the sample loading system further comprises a duct plug removably positionable in the loading end of the loading duct and when the duct plug is positioned in the loading end of the loading duct, the duct plug blocks a neutron line of sight between the target chamber and the loading end of the loading duct.

In some embodiments, the sample test housing and target chamber are each housed in a bunker comprising a bunker floor and one or more bunker walls; water is positioned in the bunker forming a water pool; and the sample test housing and the target chamber are positioned in the water pool.

In some embodiments, the sample test housing and the target chamber are positioned in the water pool wholly below a water line of the water pool.

In some embodiments, the loading end of the loading duct is positioned above a water line of the water pool.

In some embodiments, the loading duct comprises a lowered sump area.

In some embodiments, the lowered sump area is positioned at an intersection of the descent segment and the approach segment.

In some embodiments, the target chamber is positioned such that the sample test housing surrounds the target chamber.

In some embodiments, the sample test housing further comprises a source receiving slot, and the target chamber is positioned in the source receiving slot of the sample test housing such that the sample test housing surrounds the target chamber.

In some embodiments, the neutron generator further comprises a low-pressure chamber positioned along the beamline between the beam accelerator and the target chamber; the target chamber houses tritium; and the ion beam comprises a deuterium beam.

According to another embodiment of the present disclosure, a radiation effects testing system includes a sample test housing, a neutron generator comprising a beam accelerator configured to generate an ion beam, a target chamber, and a beamline extending from the beam accelerator to the target chamber, a sample loading system comprising a loading duct having a loading end and a chamber end and a rail system positioned in the loading duct, the rail system comprising a primary guide track and a secondary guide track, and a drive system, and a sample carrier comprising a base connector coupled to the primary guide track and a roof connector coupled to the secondary guide track. The sample carrier is movably coupled to the drive system such that actuation of the drive system translates the sample carrier along the rail system. The chamber end of the loading duct is coupled to the sample test housing, thereby providing a pathway from the loading end into the sample test housing. The loading duct comprises a descent segment extending from the loading end and an approach segment extending from the chamber end. The descent segment and the approach segment are non-parallel. Moreover, the sample carrier is in an upright orientation when located in the descent segment of the loading duct and when located in the approach segment of the loading duct.

In some embodiments, the drive system comprises a link mechanism coupled to a drive mechanism; and the link mechanism is positioned within the primary guide track or the secondary guide track and is coupled the sample carrier.

In some embodiments, the sample carrier comprises a base, a sidewall, and a top; the base connector of the sample carrier is positioned at an intersection of the base and the sidewall; and the top extends from the sidewall to a leading top edge and the roof connector is positioned at the leading top edge.

In some embodiments, the drive system comprises: a first link mechanism coupled to the sample carrier via the primary guide track; and a second link mechanism coupled to the sample carrier via the secondary guide track; wherein the first and second link mechanisms are configured to translate synchronously.

In some embodiments, the sample loading system further comprises a cable feeding mechanism configured to automatically manage cable length in the loading duct during translation of the sample carrier.

According to another embodiment of the present disclosure, a method of performing radiation effects testing includes loading a test sample onto a sample carrier, translating the sample carrier along a loading duct of a sample loading system and into a sample test housing, wherein the sample carrier is in an upright orientation when translating along the loading duct, and generating neutrons in a target chamber of a neutron generator positioned such that the neutrons irradiate the test sample in the sample test housing.

In some embodiments, the method further comprises subsequent to generating neutrons in the target chamber, translating the sample carrier out of the sample test housing and along the loading duct to an access position.

In some embodiments, when loading the test sample onto the sample carrier, the sample carrier is located in the access position.

In some embodiments, the loading duct comprises a loading end and a chamber end; the chamber end is coupled to the sample test housing, thereby providing a pathway from the loading end into the sample test housing; the loading duct comprises a descent segment extending from the loading end and an approach segment extending from the chamber end; the descent segment and the approach segment are non-parallel; and the sample carrier is in an upright orientation when translating along the descent segment of the loading duct and when translating along the approach segment of the loading duct.

In some embodiments, the sample test housing and target chamber are each housed in a bunker comprising a bunker floor and one or more bunker walls; and when generating neutrons in the target chamber, water is positioned in the bunker forming a water pool such that the sample test housing and the target chamber are positioned in the water pool.

In some embodiments, the sample test housing surrounds that target chamber.

In some embodiments, generating neutrons comprises accelerating an ion beam from a beam accelerator into the target chamber such that the ion beam interacts with a target to generate the neutrons via a fusion reaction.

In some embodiments, the neutrons generated via the fusion reaction comprise an average energy of greater than 10 MeV.

In some embodiments, the test sample comprises an electronic component.

In some embodiments, the electronic component is electrically coupled to a power source while the neutrons irradiate the electronic component.

In some embodiments, the method further comprises operating the electronic component while neutrons irradiate the electronic component, and monitoring operation of the electronic component while neutrons irradiate the electronic component.

In some embodiments, the sample carrier is coupled to a rail system positioned within the loading duct.

In some embodiments, a plurality of single event upsets occur in the test sample when neutrons irradiate the test sample in the sample test housing, a percentage of the plurality of single event upsets that are caused by neutrons having an energy greater than 10 MeV is 60% or greater.

In some embodiments, a plurality of single event upsets occur in the test sample when neutrons irradiate the test sample in the sample test housing, a percentage of the plurality of single event upsets that are caused by neutrons having an energy greater than 10 MeV is 90% or greater.

In some embodiments, translating the sample carrier comprises actuating a drive system coupled to link mechanisms in multiple guide tracks.

In some embodiments, the method further comprises automatically feeding cable connected to the test sample into the loading duct at a rate synchronized with translation of the sample carrier.

In some embodiments, automatically feeding cable comprises rotating a feeding element operatively coupled to a drive system that translates the sample carrier.

According to yet another embodiment of the present disclosure, a method of performing radiation effects testing includes loading a test sample onto a sample carrier coupled to a rail system of a sample loading system, wherein the sample loading system further comprises a loading duct having a loading end and a chamber end, the chamber end is coupled to a sample test housing, the loading duct comprises a descent segment extending from the loading end and an approach segment extending from the chamber end, the descent segment and the approach segment are non-parallel, the rail system comprises a primary guide track and a secondary guide track, and the carrier frame comprises a base connector coupled to the primary guide track and a roof connector coupled to the secondary guide track. The method further includes translating the sample carrier along the rail system and into the sample test housing, wherein the sample carrier is in an upright orientation when translating along the descent segment of the loading duct and when translating along the approach segment of the loading duct and generating neutrons in a target chamber of a neutron generator positioned such that the neutrons irradiate the test sample in the sample test housing.

In some embodiments, the sample test housing and target chamber are each housed in a bunker comprising a bunker floor and one or more bunker walls; and when generating neutrons in the target chamber, water is positioned in the bunker forming a water pool such that the sample test housing and the target chamber are positioned in the water pool.

In some embodiments, the sample test housing surrounds that target chamber.

In some embodiments, generating neutrons comprises accelerating an ion beam from a beam accelerator into the target chamber such that the ion beam interacts with a target to generate the neutrons via a fusion reaction.

In some embodiments, the neutrons generated via the fusion reaction comprise an average energy of greater than 10 MeV.

In some embodiments, the test sample comprises an electronic component.

In some embodiments, the electronic component is electrically coupled to a power source while the neutrons irradiate the electronic component.

In some embodiments, the method further comprises operating the electronic component while neutrons irradiate the electronic component, and monitoring operation of the electronic component while neutrons irradiate the electronic component.

In some embodiments, a plurality of single event upsets occur in the test sample when neutrons irradiate the test sample in the sample test housing, a percentage of the plurality of single event upsets that are caused by neutrons having an energy greater than 10 MeV is 60% or greater.

In some embodiments, a plurality of single event upsets occur in the test sample when neutrons irradiate the test sample in the sample test housing, a percentage of the plurality of single event upsets that are caused by neutrons having an energy greater than 10 MeV is 90% or greater.

Additional features and advantages will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts an embodiment of a radiation effects testing system that includes a neutron generator, a sample test housing, and a sample loading system according to embodiments disclosed and described herein.

FIG. 2 schematically depicts the sample test housing and the sample loading system of FIG. 1 in more detail, according to one or more embodiments disclosed and described herein.

FIG. 3 schematically depicts a sectional view of the sample test housing and the sample loading system of FIG. 2 along line A-A, according to one or more embodiments disclosed and described herein.

FIG. 4A schematically depicts a partial cut sectional of the sample test housing and the sample loading system of FIG. 2 along line A-A with a sample carrier in an access position, according to one or more embodiments disclosed and described herein.

FIG. 4B schematically depicts a partial cut sectional of the sample test housing and the sample loading system of FIG. 2 along line A-A with the sample carrier in a descent segment of a loading duct of the sample loading system, according to one or more embodiments disclosed and described herein.

FIG. 4C schematically depicts a partial cut sectional of the sample test housing and the sample loading system of FIG. 2 along line A-A with the sample carrier in an approached segment of a loading duct of the sample loading system, according to one or more embodiments disclosed and described herein.

FIG. 5A depicts a sample carrier of a sample loading system with a cable holder position in a descent segment of a loading duct of the sample loading system, according to one or more embodiments disclosed and described herein.

FIG. 5B depicts a sample carrier of a sample loading system with a cable holder position in an approach segment of a loading duct of the sample loading system, according to one or more embodiments disclosed and described herein.

FIG. 6A schematically depicts a drive system of a sample loading system of a radiation effects testing system, according to one or more embodiments disclosed and described herein.

FIG. 6B depicts a drive mechanism of the drive system of FIG. 6A, according to one or more embodiments disclosed and described herein.

FIG. 7 depicts a sample carrier of a sample loading system with a secondary link mechanism and connecting arms extending from the drive plate in an approach segment of a loading duct, according to one or more embodiments disclosed and described herein.

FIGS. 8A and 8B depict perspective views of a cable feeding system of the sample loading system, showing the feeding drum, tensioning drum, drive linkage, and support frame, according to one or more embodiments disclosed and described herein.

FIG. 9A depicts a side view of the cable feeding system of FIGS. 8A and 8B with the tensioning drum in an engaged position.

FIG. 9B depicts a side view of the cable feeding system of FIGS. 8A and 8B with the tensioning drum in a disengaged position.

### DETAILED DESCRIPTION

Reference will now be made in detail to embodiments of radiation effects testing systems that include a neutron generator, a sample test housing, and a sample loading system, embodiments of which are illustrated in the accompanying drawings. The radiation effects testing system operates as a fusion-prototypic neutron source (FPNS) for testing electronics and other components and materials under neutron bombardment. For example, the neutron generator is an accelerator-based neutron generator that includes a beam accelerator configured to form and accelerate an ion beam along a beamline that terminates at a target chamber. The target chamber houses a target that interacts with the ion beam to generate neutrons. The sample test housing is configured to house a sample carrier holding a test sample, and is positioned near the target chamber, for example, surrounding the target chamber. Thus, neutrons generated in the target chamber reach the sample test housing and irradiate test samples located in the sample test housing.

In some embodiments, the neutron generator is configured to generate neutrons with a high neutron flux in the 14.1 MeV spectrum to emulate the neutron-induced damage of a deuterium-tritium reaction on materials. Thus, the radiation effects testing system could be used to qualify materials and electronic components for use in areas of fusion power development, aerospace, and defense. For example, the materials that will be used in fusion reactors will be subjected to intense fluxes of 14.1 MeV neutrons during operation from the deuterium-tritium (DT) reaction. This will occur in multiple locations within a fusion reactor, such as the plasma-facing and inner wall components of a vacuum vessel and the structural materials within the tritium breeding blanket. Independent of the technology used to achieve fusion, the materials used are expected to incur doses of 20 to 50 displacements per atom (dpa) per full power year (fpy) at temperatures ranging from 300° C. to 1000° C. Additionally, conventional tritium breeding techniques mix breeding materials with structural materials. The radiation effects testing system described herein may also be used to test the integrity of the solid breeder materials under these same conditions. Moreover, the high energy neutrons generated using the neutron generator may be used to test the integrity and operational capabilities of components, such as electronic components, by emulating neutron irradiation that can occur in outer space, such as in earth orbit or deep space, and emulating the high energy neutrons that defense and other infrastructure components would undergo in the event of a nuclear incident. Accordingly, the radiation effects testing system can help solve some of the difficult challenges of designing and building materials and electronics capable of withstanding intense neutron environments, supporting the realization of fusion power as a commercially viable energy source, and supporting the development of aerospace and defense related components.

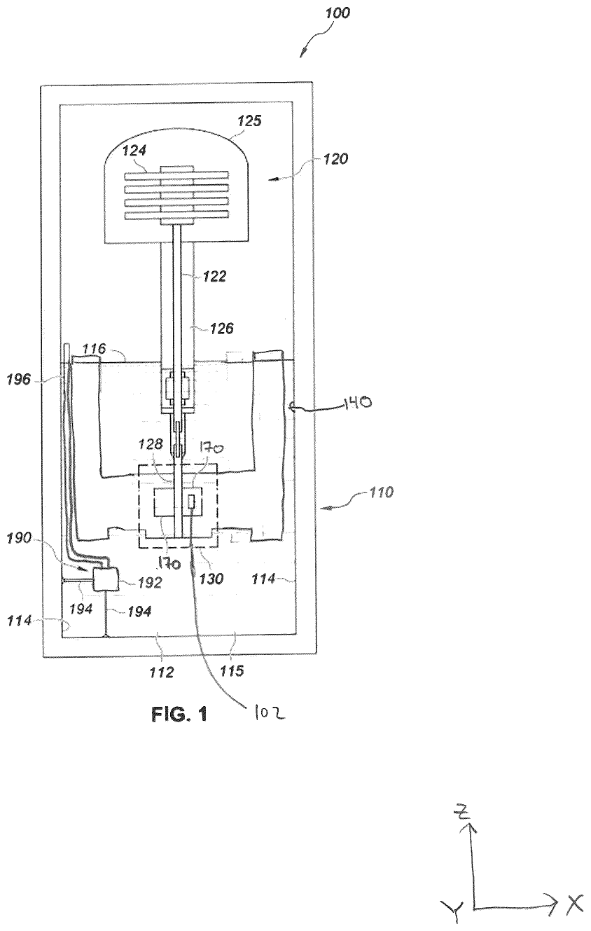

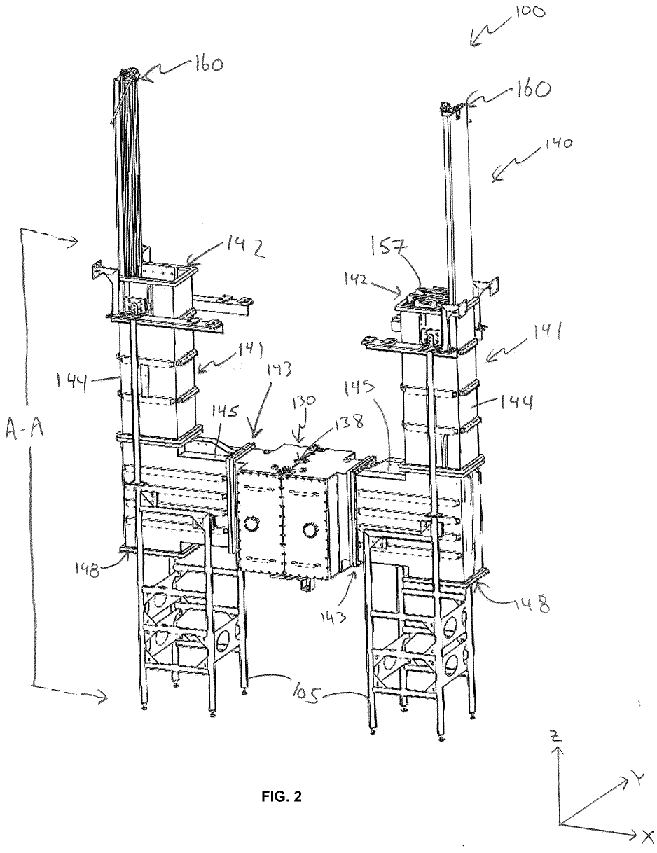

Referring now to FIGS. 1-4C, a radiation effects testing system 100 comprising a neutron generator 120, a sample test housing 130, a sample loading system 140, and target support structure 105 (FIG. 2) is schematically depicted. The neutron generator 120 is configured to produce neutrons in a target chamber 128 to irradiate a test sample 102. The sample test housing 130 is configured to house one or more test samples 102 during operation. The sample loading system 140 provides a pathway and a system for loading and unloading test samples 102 to and from the sample test housing 130. The sample loading system 140 comprises one or more loading ducts 141 each comprising a loading end 142 and a chamber end 143. The chamber end 143 is coupled to the sample test housing 130, thereby providing a pathway from the loading end 142 of a loading duct 141 to the sample test housing 130. The sample test housing 130 comprises one or more housing bodies 132 and one or more sample chambers 134 that are located inside the one or more housing bodies 132. The one or more sample openings 136 provide openings to the one or more sample chambers 134 and may be coupled to loading ducts 141 of the sample loading system 140, for example, the chamber end 143 of a loading duct 141.

The radiation effects testing system 100 further comprises one or more sample carriers 170 translatable along the one or more loading ducts 141 of the sample loading system 140, for example, between the loading end 142 and the chamber end 143 and positionable in the sample test housing 130, for example, in the one or more sample chambers 134 of the sample test housing 130. In some embodiments, the one or more sample carriers 170 comprise a base 171, a top 172, and a sidewall 173 connecting the base 171 and the top 172. Each sample carrier 170 is configured to hold one or more test samples 102 and transport the one or more test samples 102 into and out of the sample test housing 130. In operation, the test sample 102 is held on or within the sample carrier 170 during testing (e.g., while the test sample 102 is irradiated by neutrons). The one or more test samples 102 may be attached to the interior or exterior of the sample carrier 170, for example, to a removable mounting portion 179 of the sample carrier 170, which may include one or more optical breadboards for mounting electronics. Openings in the one or more optical breadboards or other openings in the sample carrier 170 may provide a pathway for wiring of test samples 102 to exit the sample carrier 170, allowing the test samples 102 to be powered and operational during testing. In some embodiments, the base 171 comprises a leading base edge 176 comprising a cutout portion 177 configured to face the target chamber 128 of the neutron generator 120 when the sample carrier 170 is positioned in the sample test housing 130, facilitating close positioning between the test sample 102 and the target chamber 128 where neutrons are generated.

Referring still to FIGS. 1-4C, the one or more loading ducts 141 comprise a descent segment 144 extending from the loading end 142 and an approach segment 145 extending from the chamber end 143. The descent segment 144 and the approach segment 145 are non-parallel and in some embodiments, are orthogonal. For example, the descent segment 144 may extend vertically from the loading end 142 and the approach segment 145 may extend horizontally from the chamber end 143. The descent segment 144 is coupled to the approach segment 145 forming a turn in the loading duct 141 at the intersection of the descent segment 144 and the approach segment 145.

Referring now to FIGS. 2-4C, a rail system 150 is positioned in the one or more loading ducts 141. The rail system 150 comprises one or more guide tracks 151 coupled to the one or more loading ducts 141 and extending from a rail loading end 152 to a rail chamber end 153. The one or more guide tracks 151 provide pathways for sample carriers 170 to travel along the rail system 150 and along the loading ducts 141. The one or more guide tracks 151 of the rail system 150 comprise a primary guide track 154 and a secondary guide track 155. The primary guide track 154 extends along a first inner wall 146 of the loading duct 141 and the secondary guide track 155 extends along a second inner wall 147 of the loading duct 141. The primary guide track 154 and the secondary guide track 155 each extend vertically along the descent segment 144 of the loading duct 141 and horizontally along the approach segment 145 of the loading duct 141. The primary guide track 154 and the secondary guide track 155 each turn in the loading duct 141 at the intersection of the descent segment 144 and the approach segment 145. In some embodiments, the loading duct 141 further comprises a lowered sump area 148, positioned at the bottom of the descent segment 144 below the primary guide track 154, for example at the intersection of the descent segment 144 and the approach segment 145. The lowered sump area 148 may extend below the bottom of the approach segment 145 in a vertical (e.g., Z) direction and provides an area for any dropped objects to collects out of the pathway formed by the guide tracks 151, minimizing disruption to the operation of the radiation effects testing system 100.

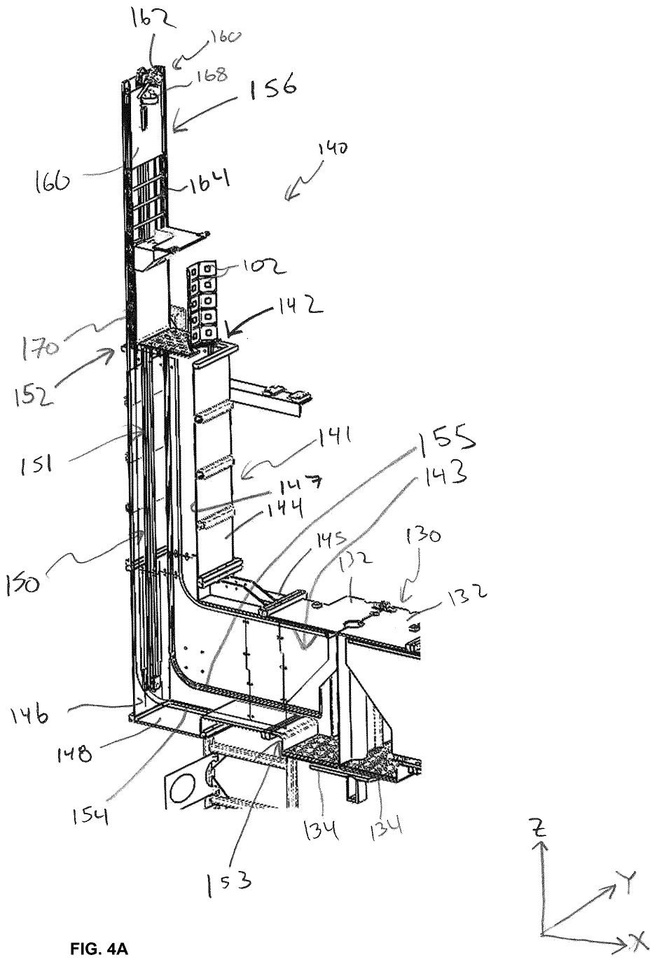

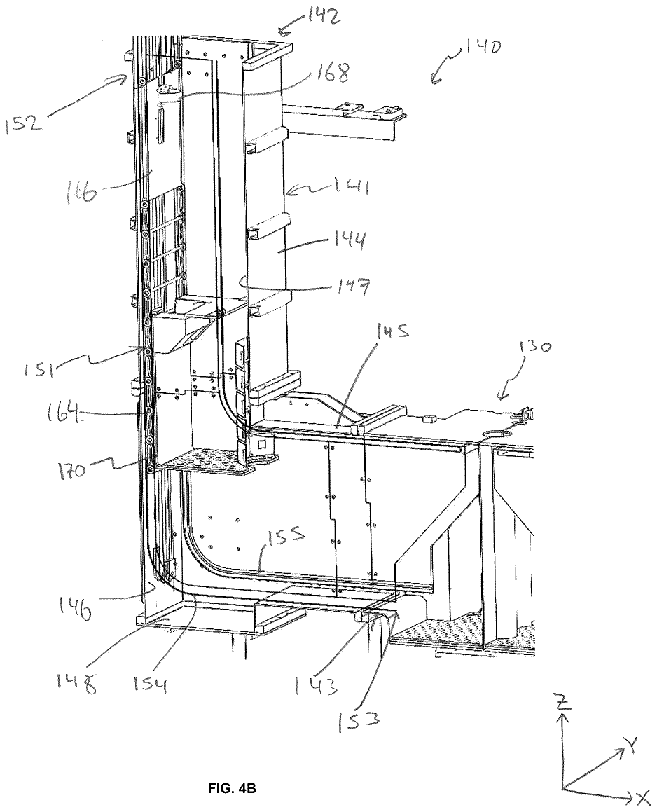

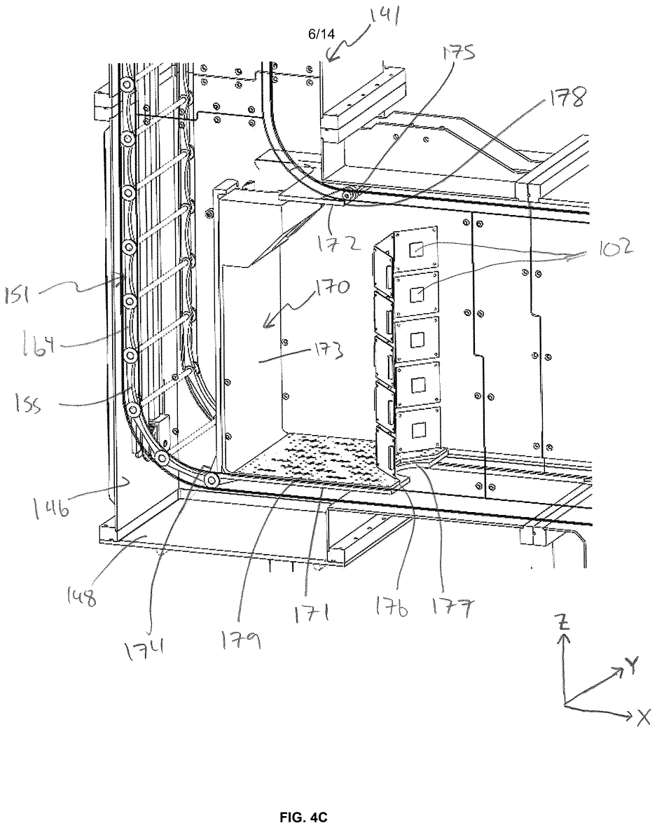

Referring now to FIGS. 4A-4C, the sample carrier 170 can be coupled to the guide tracks 151 such that the sample carrier 170 can travel within the loading duct 141 to and from the sample test housing 130. The sample carrier 170 comprises a base connector 174 coupled to the primary guide track 154 and a roof connector 175 coupled to the secondary guide track 155. In some embodiments, the base connector 174 is positioned at the intersection of the base 171 and the sidewall 173 of sample carrier 170. The top 172 extends from the sidewall 173 to a leading top edge 178 and the roof connector 175 is positioned at the leading top edge 178. The removable mounting portion 179 is removably coupled to one or more of the base 171, the sidewall 173, and the top 172. As depicted in FIGS. 4A-4C, the sample carrier 170 is in an upright orientation when located in the descent segment 144 of the loading duct 141 and when located in the approach segment 145 of the loading duct 141. Thus, the test sample 102 is held steady while transporting the test sample 102 into and out of the sample test housing 130, facilitating reliable and repeatable positioning of the test sample 102 in the sample test housing 130. The sample carrier 170 may further comprise a cable holder 180 configured to hold the wiring of the test sample 102 in a position that does not obstruct the guide tracks 151 when the sample carrier is in the descent segment 144 of the loading duct 141 (FIG. 4A) and when the sample carrier is in the approach segment 145 of the loading duct 141 (FIG. 4C).

In FIG. 4A, the sample carrier 170 is depicted positioned at the rail loading end 152 of the guide tracks 151 in an access position above the loading end 142 of the loading duct 141. The one or more guide tracks 151 extend outward from the loading end 142 of the one or more loading duct 141 to allow the sample carrier 170 and test sample 102 to be positioned outside the loading ducts 141 when loading and unloading the test sample 102. Indeed, as shown in FIG. 4A, the rail loading end 152 includes an extended loading segment 156 that extends outward from the loading end 142 of the loading duct 141. The extended loading segment 156 provides a location external to the loading duct 141 for loading and unloading the test samples 102 onto or into the sample carrier 170 and, in some embodiments, for coupling and uncoupling the sample carrier 170 to the guide tracks 151. In FIG. 4B, the sample carrier 170 is depicted coupled to the guide tracks 151 in the descent segment 144 of the loading duct 141 and in FIG. 4C, the sample carrier 170 is depicted coupled to the guide tracks 151 in the approach segment 145 of the loading duct 141.

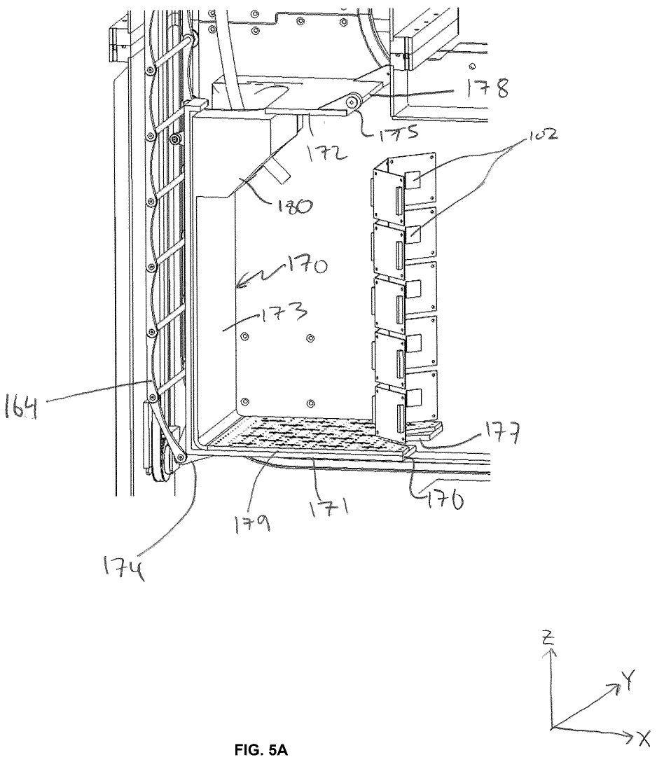

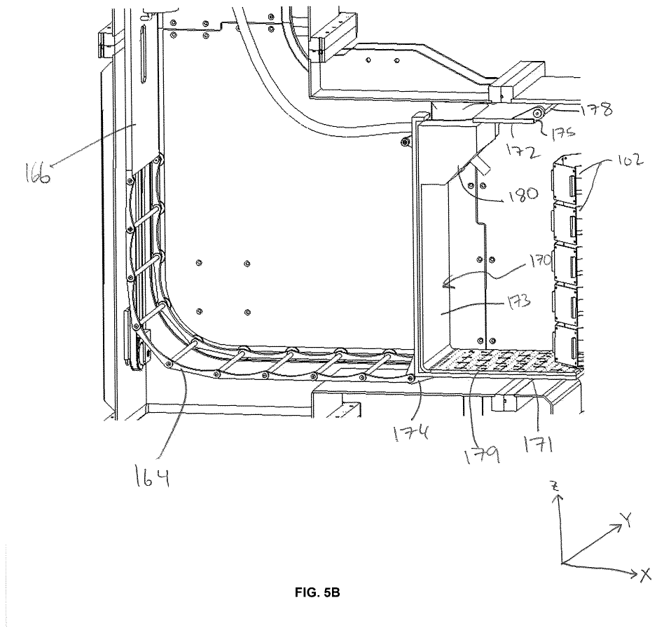

Referring now to FIGS. 1-8B, the sample loading system 140 further comprises a drive system 160 configured to translate the sample carrier 170 along the one or more loading ducts 141. The drive system 160 comprises a drive mechanism 162 coupled to a link mechanism 164 and a drive plate 166. The drive mechanism 162 is configured to translate the link mechanism 164 within the at least one guide track 151 thereby translating the sample carrier 170 along the loading duct 141. The drive mechanism 162 may comprise an electric translation mechanism with an electric motor or a pneumatic translation system with a pneumatic motor. For example, the drive mechanism 162 may comprise a servomotor, which facilitates precision positioning of the sample carrier 170 and the test sample 102 with respect to the target chamber 128. The sample loading system 140 may also include a limit switch that indicates when the sample carrier 170 and the test sample 102 are positioned in the sample test housing 130. For example, the limit switch may be positioned at the rail chamber end 153 of the primary guide track 154 and/or the secondary guide track 155. In some embodiments, it may be useful to position the drive mechanism 162 such that any electronic components of the drive mechanism 162 are positioned above or otherwise away from the loading duct 141 and the sample test housing 130 to minimize damage to such components by the radiation generated when testing the test sample 102.

The link mechanism 164 is positioned within at least one of the guide tracks 151 and coupled the sample carrier 170 and comprises a plurality of linked segments which facilitate motion of the link mechanism 164 thorough the turn in the guide tracks 151 at the intersection of the descent segment 144 and the approach segment 145 of the loading duct 141. The drive plate 166 coupled to and positioned between the drive mechanism 162 and the link mechanism 164. The drive plate 166 helps translate the power generated by the drive mechanism 162 into translational motion of the link mechanism 164 and the sample carrier 170. In operation, the drive plate 166 is positioned to remain in the descent segment 144 of the loading duct 141 when the sample carrier is in the sample test housing 130 such that the drive plate 166 remains vertical. In some embodiments, a cable retainer 168 is coupled to the drive plate 166 and helps manage positioning of cables and/or wiring the is coupled to the test sample 102.

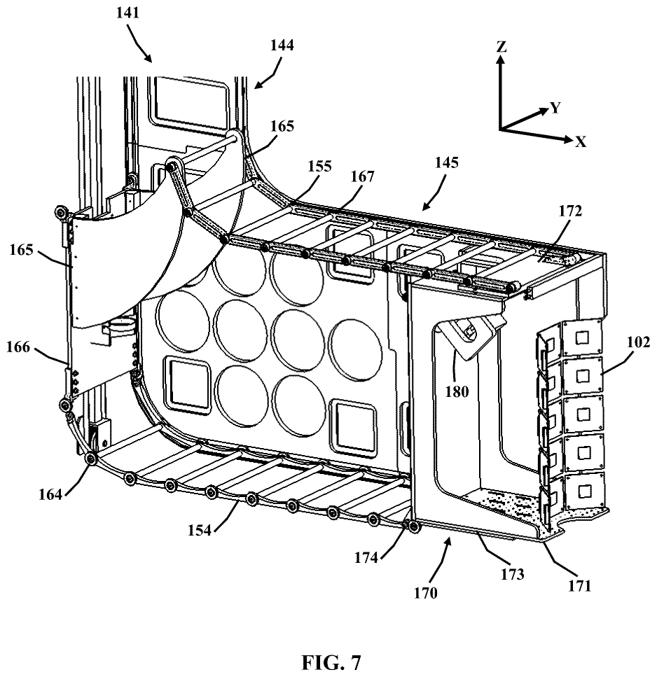

Referring now to FIG. 7, in some embodiments the sample loading system 140 further comprises a secondary link mechanism 167 positioned within the secondary guide track 155 and coupled to the sample carrier 170. The secondary link mechanism 167 is coupled to the drive plate 166 via connecting arms 165 that extend laterally from opposite sides of the drive plate 166. Each connecting arm 165 comprises a rigid member affixed to the drive plate 166 at a first end and coupled to the secondary link mechanism 167 at a second end. The connecting arms 165 may comprise aluminum, steel, or other suitable structural materials capable of transmitting the translational force from the drive mechanism 162 to the secondary link mechanism 167.

The secondary link mechanism 167 comprises a plurality of linked segments, each pivotally connected to adjacent segments, similar in construction and design to the link mechanism 164. Each linked segment of the secondary link mechanism 167 may comprise rollers or bearings configured to travel within the secondary guide track 155 with minimal friction. The secondary link mechanism 167 facilitates smooth motion through the turn in the secondary guide track 155 at the intersection of the descent segment 144 and the approach segment 145 of the loading duct 141. The dual-track drive configuration, with the link mechanism 164 in the primary guide track 154 and the secondary link mechanism 167 in the secondary guide track 155, provides enhanced stability and control of the sample carrier 170 during translation, distributing the load more evenly and reducing the potential for binding or misalignment. This configuration is particularly advantageous when navigating the turn between the descent segment 144 and the approach segment 145, helping to maintain the upright orientation of the sample carrier 170 throughout its travel path and minimizing vibration or displacement of the test sample 102 during loading and unloading operations.

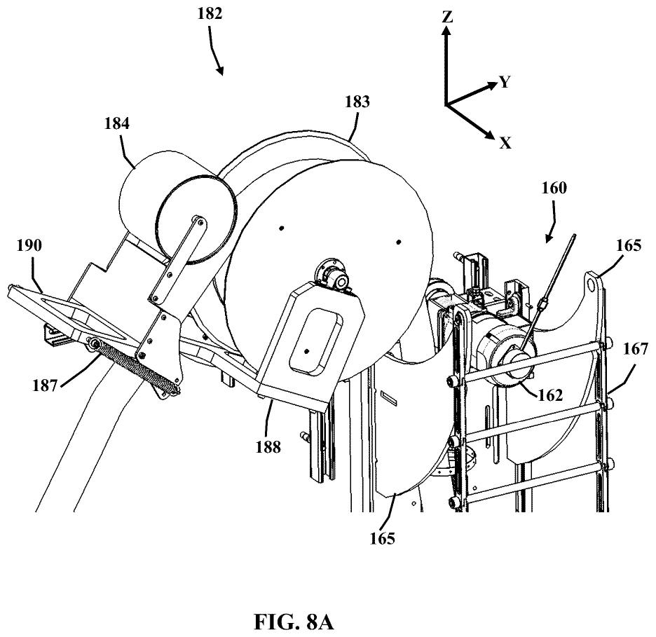

Referring now to FIGS. 8A-8B, in some embodiments the sample loading system 140 further comprises a cable feeding system 182 coupled to the drive system 160 and positioned above the loading duct 141, for example, mounted to a support frame 188 positioned at or near the loading end 142 of the loading duct 141. The cable feeding system 182 is configured to manage the feeding and retraction of cables or wiring connected to the test sample 102 as the sample carrier 170 translates along the loading duct 141, reducing the likelihood of cable tangling, kinking, or interference with the guide tracks 151. The cable feeding system 182 comprises a feeding drum 183 and a tensioning drum 184 (e.g., a tensioning element), each rotatably mounted on respective drum axles. The feeding drum 183 is operatively coupled to the drive mechanism 162 via a drive linkage 185, which may comprise a chain and sprocket assembly 186. The chain and sprocket assembly 186 includes a drive sprocket 186a coupled to the drive mechanism 162 and a driven sprocket 186b coupled to the feeding drum 183, with a drive chain 186c connecting the drive sprocket 186a and the driven sprocket 186b. The gear ratio between the drive sprocket 186a and the driven sprocket 186b may be selected such that the rotation of the feeding drum 183 is synchronized with the translation speed of the sample carrier 170, ensuring that cable is fed into or retracted from the loading duct 141 at the same linear rate as the sample carrier 170 translates.

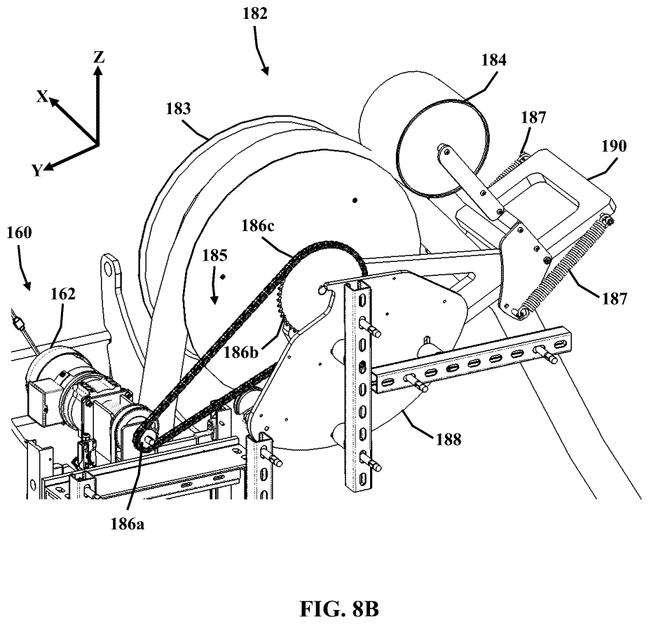

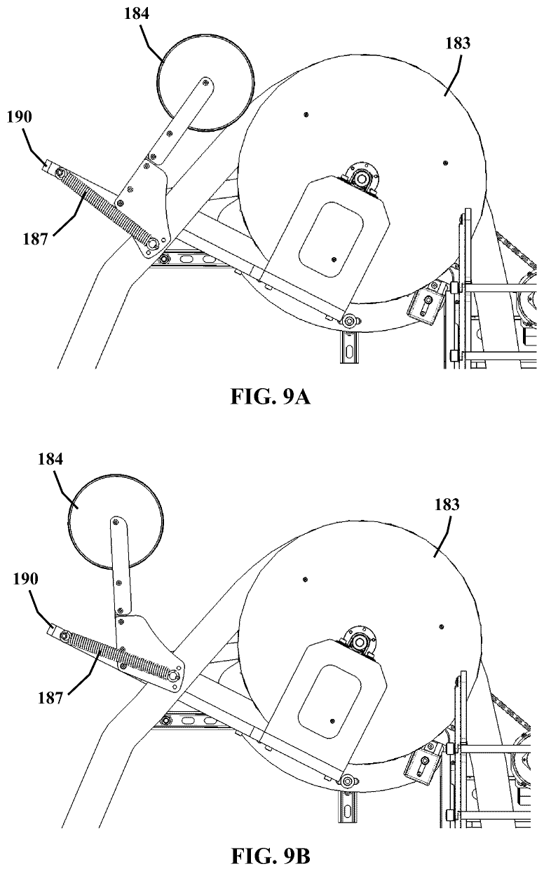

The tensioning drum 184 is positioned adjacent to and parallel with the feeding drum 183, with the cable passing through a gap formed between the feeding drum 183 and the tensioning drum 184. In some embodiments, the tensioning drum 184 is movable between an engaged position (FIG. 9A, where the tensioning drum 184 abuts the cable) and a disengaged position (FIG. 9B, where the tensioning drum 184 is spaced from the cable). In the disengaged position, the cable may be removed from the feeding drum 183, for example. The tensioning drum 184 is mounted on a movable bracket 190 that allows the tensioning drum 184 to move toward and away from the feeding drum 183. One or more biasing elements 187, such as compression springs or tension springs, are coupled to the movable bracket 190 and bias the tensioning drum 184 against the feeding drum 183 with a predetermined force. The biasing force is selected to maintain appropriate tension on the cable to prevent slack or binding while allowing the cable to move smoothly between the drums. In some embodiments, the moveable bracket 190 and the biasing element 187 are part of an over-center assembly. The tensioning drum 184 may comprise a rubber or elastomeric outer surface to provide appropriate friction against the cable without damaging the cable insulation.

In operation, as the drive mechanism 162 translates the sample carrier 170 downward through the descent segment 144, the feeding drum 183 rotates to feed cable into the loading duct 141, with the cable passing from the cable feeding system 182 to the cable retainer 168 and subsequently to the cable holder 180 on the sample carrier 170. Conversely, when the sample carrier 170 is translated upward for removal, the feeding drum 183 rotates in the opposite direction to retract the cable, preventing cable accumulation in the loading duct 141. The cable feeding system 182 works to facilitate smooth cable management during loading and unloading operations while maintaining the integrity of the electrical connections to the test sample 102 and preventing cable damage.

In the embodiments depicted in FIGS. 1-8B, the sample test housing 130 comprises a first housing body, a first sample chamber within the first housing body, a first sample opening in the first housing body, which opens to the first sample chamber. The sample test housing 130 also comprises a second housing body, a second sample chamber within the second housing body 13B, a second sample opening in the second housing body, which opens to the second sample chamber. The sample loading system 140 comprises a first loading duct coupled to the first sample opening of the sample test housing and a second loading duct coupled to the second sample opening of the sample test housing 130. While the sample test housing of 130 depicted in FIGS. 1-4C includes two housing bodies and two sample chambers and the sample loading system 140 comprises two loading ducts, it should be understood that any number of housing bodies 132, sample chambers 134, and loading ducts 141 are contemplated. Indeed, embodiments are contemplated with a single housing body 132 and a single sample chamber 134 connected to one or more loading ducts 141 and embodiments are contemplated having three or more housing bodies 132, three or more sample chambers 134, and three or more loading ducts 141 where at least one loading duct 141 is coupled to each of the three or more sample chambers 134.

Referring still to FIGS. 1-8B, in some embodiments, the target chamber 128 of the neutron generator 120 is positioned such that the sample test housing 130 surrounds the target chamber 128. For example, the first housing body is positioned adjacent the second housing body such that the first housing body and the second housing body collectively surround the target chamber 128 of the neutron generator 120. In some embodiments, the first housing body is coupled to the second housing body. The sample test housing 130 further comprises a source receiving slot 138 and the target chamber 128 of the neutron generator 120 is positioned in the source receiving slot 138 such that the sample test housing 130 surrounds the target chamber 128. In some embodiments, as shown in FIGS. 2-4, the source receiving slot 138 is collectively formed by indented portions of each housing body 132, which collectively surround the target chamber 128 and separate the target chamber 128 from the sample chamber 134. The source receiving slot 138 allows the target chamber 128 to be in close proximity to the sample chamber 134 and the test sample 102, without entering the sample chamber 134, allowing the sample chamber 134 to remain dry. Moreover, positioning the one or more sample chambers 134 around the target chamber 128, maximizes the neutron flux within each sample chamber 134 and thus the neutron flux that impinges the test sample 102. While the radiation effects testing system 100 is primarily described in which the sample test housing 130 surrounds the target chamber 128 of the neutron generator 120, embodiments are contemplated in which the target chamber 128 is positioned near the sample test housing 130, for example adjacent the sample test housing 130 without being surrounded by the sample test housing 130. Such examples include embodiments in which the sample test housing 130 comprises a single housing body 132 and a single sample chamber 134. Alternatively, it is contemplated that a sample test housing 130 comprising a single housing body 132 and a single sample chamber 134 may include a source receiving slot 138 extending into the single housing body 132 such that the single sample chamber 134 surrounds the source receiving slot 138 and surrounds the target chamber 128 positioned therein.

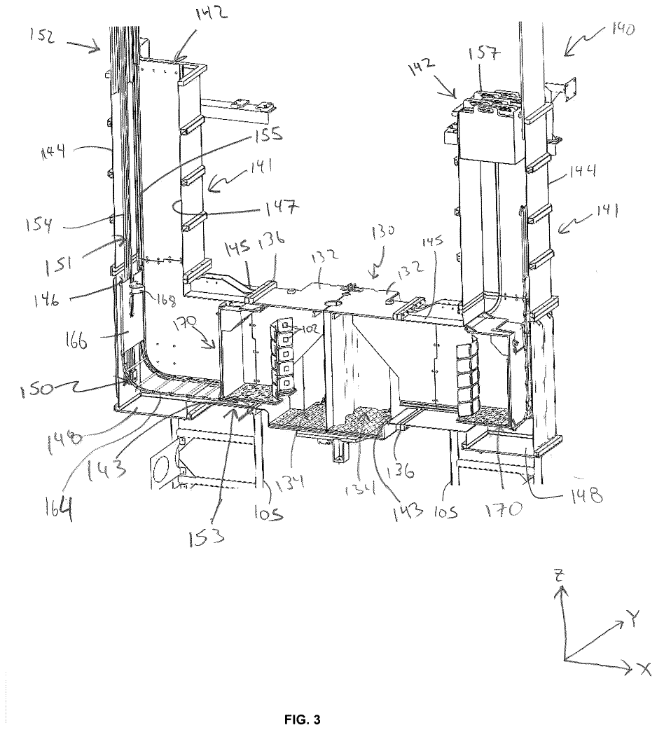

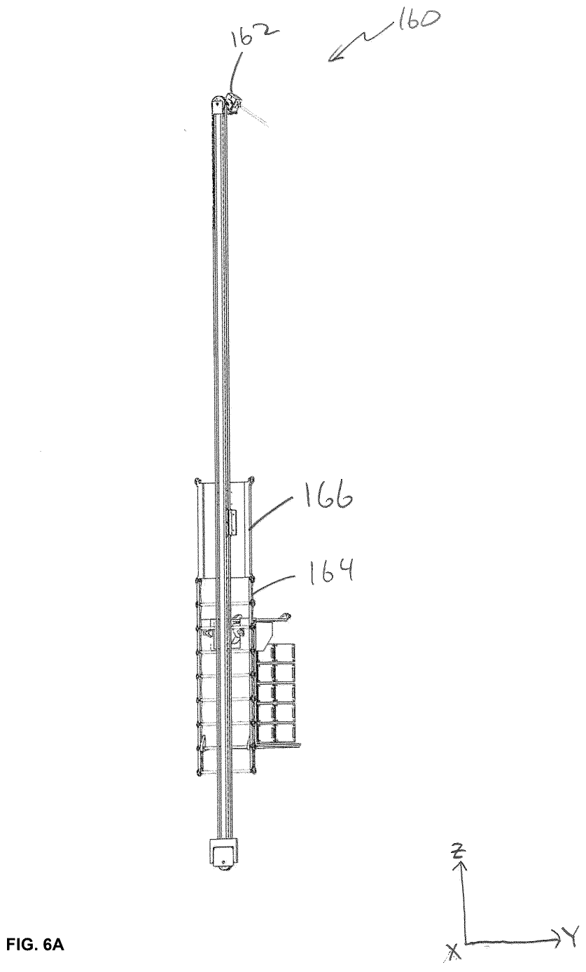

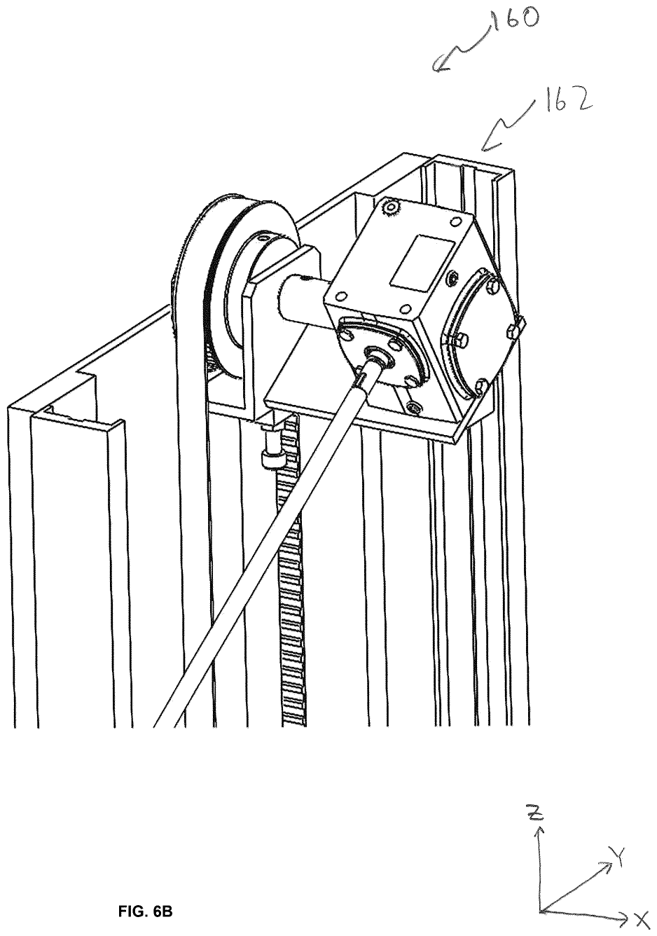

Referring again to FIGS. 2 and 3, in some embodiments, the sample loading system 140 further comprises one or more duct plugs 157, each removably positionable in the loading end 142 of the one or more loading ducts 141. The one or more duct plugs 157 may comprise one or more plug slats and a plug basket. The one or more plug slats each comprise a radiation shielding material, such as high-density polyethylene (HDPE), borated polyethylene, lead, or any other know or yet to be developed radiation shielding material. The one or more plug slats are positioned in the plug basket, for example, removably positioned, and may be laterally spaced to provide openings for wiring connected to the one or more test samples 102 to exit the loading duct 141 when the sample carrier 170 and test sample 102 are loaded in the sample chamber 134. Indeed, the loading duct 141 may provide a pathway for wiring of test samples 102 that comprises electronic components to reach above the water line 116, allowing the test samples 102 to be powered and operational during testing. The plug basket comprises a perimeter lip that engages with the loading end 142 of the loading duct 141, holding the plug basket and the one or more plug slats in the loading duct 141 at the loading end 142. In some embodiments, the plug basket includes one or more slots for holding the plug slats is a laterally spaced arrangement. Moreover, when the duct plug 157 is positioned in the loading end 142 of one of the loading ducts 141, the one or more plug slats block a neutron line of sight between the target chamber 128 and the loading end 142 of the loading duct 141. While the one or more duct plugs 157 are depicted in FIG. 6 as one or more plug slats and the plug basket, embodiments are contemplated in which the one or more duct plugs are unitary duct plugs comprising a radiation shielding material that is unitary and is insertable into the loading end 142 of the loading duct 141. Moreover, embodiments are contemplated in which the one or more duct plugs 157 comprise insertable containers that are configured to hold water such that water held in these insertable containers may operate as the radiation shielding material of the one or more duct plugs 157.

Referring again to FIG. 1, the neutron generator 120 comprises a beamline 122 extending from a beam accelerator 124 to a target chamber 128. A low-pressure chamber 126 is positioned along the beamline 122 to provide a low-pressure environment for ion beam travel. Indeed, the beam accelerator 124 configured to generate an ion beam that is directed to the low-pressure chamber 126 (e.g., a beam accelerator region). In some embodiments, the beam accelerator 124 is housed within a high-voltage dome 125. In embodiments, the low-pressure chamber 126 is operated under vacuum conditions. The target chamber 128 houses a target, which may comprise a target gas, such as deuterium, tritium, helium, or argon, for embodiments in which neutrons are generated using a fusion reactions, or alternatively may comprise a solid target, for example, a beryllium target, for embodiments in which neutrons are generated using a spallation reaction. It should be understood that the neutron generator 120 in FIG. 1 is merely schematic and is not to scale. In some embodiments, the neutron generator 120 operates by first extracting a beam of deuterium from the beam accelerator 124, which may comprise an electron cyclotron resonance (ECR) based ion source. The deuterium beam is accelerated via stepped electrostatic potentials such that a desired deuterium-tritium fusion cross-section is achieved when the deuterium beam enters the gaseous tritium target, located in the target chamber 128, generating neutrons via a fusion reaction. In some embodiments, the deuterium beam is focused through a gas-flow-restricting aperture that separates the beam acceleration region (e.g., the low-pressure chamber 126) from the target chamber 128.

Referring still to FIG. 1, the target support structure 105, the sample test housing 130, and at least a target chamber 128 of the neutron generator 120 are positioned in a bunker 110 comprising a bunker floor 112, one or more bunker walls 114, and may include a water pool 115 comprising a depth extending from the bunker floor 112 to a water line 116. The water in the water pool 115 may comprise light water or heavy water. The target support structure 105 provides physical support for the sample test housing 130, and the sample loading system 140 and helps hold them in place both when the water pool 115 is present and when the water pool 115 is removed (e.g., drained from the bunker 110). The water pool 115 may be fluidly coupled to a fluid pumping system configured to selectively remove water from the bunker 110 and direct water into the bunker 110 to form and remove the water pool 115. When the water pool 115 is present in the bunker, the sample test housing 130 and the target chamber 128 are positioned in the water pool 115 below the water line 116, for example, wholly below the water line 116. The water pool 115 provides neutron moderation in the bunker 110 and, as described in more detail below, the sample loading system 140 provides a dry pathway for test samples 102 to be loaded and unloaded from the sample test housing 130. When the water pool 115 is present in the bunker 110, the loading end 142 of each of the one or more loading ducts 141 is positioned above the water line 116, to provide a dry pathway to load test samples 102 into the sample test housing 130 and remove the one or more test samples 102 from the sample test housing 130.

As shown in FIG. 1, the radiation effects testing systems 100 may also include one or more auxiliary sample container systems 190. The one or more auxiliary sample container systems 190 provide an auxiliary container 192 for test samples 102 to be positioned in locations throughout the bunker 110, for example, positioned in the water pool 115. This allows the neutron dose applied to the test samples 102 to be varied, providing additional testing flexibility. For example, the one or more auxiliary sample container systems 190 may be used to determine a maximum neutron dose a test sample 102 can undergo, particularly when the dose rates in the sample test housing 130 are beyond that maximum. The auxiliary sample container systems 190 may further comprise a tether 194 to couple the auxiliary container 192 to the bunker floor 112 and/or a bunker wall 114, holding the auxiliary container under the water line 116, and an access tube 196 to provide a dry pathway for any wiring connected to the test sample 102 to reach above the water line 116.

Referring again to FIGS. 1-8B, operation of the radiation effects testing system 100 will now be described. First, the one or more test samples 102 are loaded into the sample test housing 130, in particular, into one or more of the sample chambers 134 of the sample test housing 130, using the sample loading system 140. In particular, one or more test samples 102 may be loaded onto or into the sample carrier 170, which may then be coupled to the one or more guide tracks 151. For example, the test sample 102 may be loaded onto (e.g., coupled to) the removable mounting portion 179 of the sample carrier 170 while the removable mounting portion 179 is separated from the sample carrier 170. The removable mounting portion 179 may then be coupled to the sample carrier 170. The sample carrier 170 may then be guided along the one or more guide tracks 151 to reach the sample chamber 134. For example, the sample carrier 170 may be lowered along the one or more guide tracks 151 using the drive system 160. In some embodiments incorporating the cable feeding system 182, actuation of the drive mechanism 162 simultaneously translates the sample carrier 170 and rotates the feeding drum 183 via the drive linkage 185, automatically managing cable feed rates to match the carrier translation speed. Once the sample carrier 170 is loaded into the sample test housing 130, the duct plug 157 may be positioned in the loading end 142 of the loading duct 141. When loading the test sample 102 into the sample test housing 130 using the sample loading system 140, the water pool is present in the bunker 110 and the loading end 142 of the loading duct 141 is positioned above the water line 116.

Next, neutrons are generated in the target chamber 128 of the neutron generator 120 and at least a portion of the generated neutrons irradiate the one or more test samples 102 positioned in the one or more sample chambers 134 for an irradiation period. When generating neutrons in the target chamber 128, water may be positioned in the bunker 110 forming the water pool 115 and the sample test housing 130 and the target chamber 128 are positioned in the water pool. After the irradiation period, the one or more test samples 102 are removed from the sample chamber 134, for example, using the sample loading system 140. For example, after the irradiation period, the duct plug 157 is removed from the loading end 142 of the loading duct 141 and the sample carrier 170, and thereby the test sample 102, is transported from the sample test housing 130 along the guide tracks 151, for example, using the drive system 160 to translate the sample carrier 170 toward the loading end 142 of the loading duct 141, where the test sample 102 may be removed, allowing another test sample 102 to be tested. For example, the removable mounting portion 179 may be separated from the sample carrier 170 and then the test sample 102 may be removed from the removable mounting portion 179, which facilitates user friendly loading and unloading of the test sample 102.

The neutron generator 120 operates by extracting an ion beam of deuterium from the beam accelerator 124 and accelerating the deuterium beam via stepped electrostatic potentials such that a desired deuterium-tritium (DT) fusion cross-section is achieved when the deuterium beam enters the gaseous tritium target, located in the target chamber 128, generating neutrons via a fusion reaction. In operation, the ion beam may be accelerated and directed into the target chamber 128 as a continuous ion beam or a pulsed ion beam. The neutrons generated via the DT fusion reaction may comprise an average energy of greater than 8 MeV, for example, greater than 9 MeV, greater than 10 MeV, greater than 11 MeV, greater than 12 MeV, greater than 13 MeV, greater than 14 MeV, or any average in a range having any two of these values as endpoints. In some embodiments, the target chamber 128 may house a deuterium gas target such that the neutrons generated by a deuterium-deuterium (DD) fusion reaction. Such DD fusion neutrons may comprise an average energy of greater than 1 MeV, for example, greater than 1.5 MeV, greater than 2 MeV, greater than 2.5 MeV, greater than 3 MeV, or any average in a range having any two of these values as endpoints.

Without intending to be limited by theory, neutrons generated by a DT reaction (DT fusion neutrons) are particularly desirable for testing since they produce the desired ratio among hydrogen production rate, helium production rate, and displacement rates for an FPNS. For 14.1 MeV neutrons incident upon an iron target, the helium production rate to displacement rate ratio is 19.1 atomic parts per million (appm)/displacements per atom (dpa), and the hydrogen production rate to displacement rate ratio is 73.1 appm/dpa. As neutron energy is reduced from 14.1 MeV, hydrogen and helium production cross sections drop off much more quickly than displacement cross sections. As such, DT fusion neutrons are preferred over fission neutrons (i.e., neutrons produced by a fission reaction) which are mostly below 2 MeV and with near zero population at 10 MeV. In some embodiments, the neutrons generated via the fusion reaction in the target chamber 128 may comprise an average energy of greater than 10 MeV, for example, greater than 11 MeV, greater than 12 MeV, greater than 13 MeV, greater than 14 MeV, or an average energy in a range having any two or these values as endpoints.

As described above, the test sample 102 may comprise an electronic component, which may be tested while operating. For example, the electric component may be electrically coupled to a power source while the neutrons irradiate the electronic component. A component monitoring device, such as a computing device, may also be communicatively coupled to the electronic component, via a wired or wireless connection, to monitor the electronic component. Indeed, the method may further comprise operating the electronic component while neutrons irradiate the electronic component and monitoring operation of the of the electronic component while neutrons irradiate the electronic component. Monitoring operation of the electric component may include monitoring the operation of the hardware in the electric component and also the software operating on the electronic component. This includes monitoring whether any changes occur in the code as a result of interactions between the electronic component and radiation. The method may also include monitoring the radiation in the sample carrier 170, sample test housing 130, and the bunker 110, using one or more radiation detection devices, such as a foil detector, a domino detector, a scintillator, and combinations thereof.

As the test sample 102 is being irradiated by neutrons a plurality of single even upsets occur, which may damage the test sample 102. In operation, a percentage of the plurality of single event upsets that are caused by neutrons having an energy greater than 10 MeV is 50% or greater, for example 55% or greater, 60% or greater, 65% or greater, 70% or greater, 75% or greater, 80% or greater, 85% or greater, 90% or greater, 95% or greater, 99% or greater, or a percentage in any range having any two of these values as endpoints.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. Thus, it is intended that the specification cover the modifications and variations of the various embodiments described herein provided such modification and variations come within the scope of the appended claims and their equivalents.

As utilized herein, the terms “approximately,” “about,” “substantially”, and similar terms are intended to have a broad meaning in harmony with the common and accepted usage by those of ordinary skill in the art to which the subject matter of this disclosure pertains. Indeed, such terms refer to the subsequently listed property or measurement within normal manufacturing tolerances and imperfections in the relevant field. It should be understood by those of skill in the art who review this disclosure that these terms are intended to allow a description of certain features described and claimed without restricting the scope of these features to the precise numerical values or idealized geometric forms provided. Accordingly, these terms should be interpreted as indicating that insubstantial or inconsequential modifications or alterations of the subject matter described and claimed are considered to be within the scope of the disclosure as recited in the appended claims.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

1. A radiation effects testing system comprising:
a sample test housing;
a neutron generator comprising a beam accelerator configured to generate an ion beam, a target chamber, and a beamline extending from the beam accelerator to the target chamber; and
a sample loading system comprising a loading duct having a loading end and a chamber end; and
a sample carrier translatable along the loading duct, wherein:
the chamber end is coupled to the sample test housing, thereby providing a pathway from the loading end into the sample test housing;
the loading duct comprises a descent segment extending from the loading end and an approach segment extending from the chamber end;
the descent segment and the approach segment are non-parallel; and
the sample carrier is in an upright orientation when located in the descent segment of the loading duct and when located in the approach segment of the loading duct.

2. The radiation effects testing system of claim 1, wherein the sample carrier comprises a base, a sidewall, and a top.

3. The radiation effects testing system of claim 2, wherein the base comprises a leading base edge comprising a cutout portion configured to face the target chamber of the neutron generator when the sample carrier is positioned in the sample test housing.

4. The radiation effects testing system of claim 1, wherein the sample loading system further comprises a drive system configured to translate the sample carrier along the loading duct; wherein the sample loading system further comprises a cable feeding system operatively coupled to the drive system and configured to feed cable into the loading duct at a rate corresponding to translation of the sample carrier.

5. (canceled)

6. The radiation effects testing system of claim 4, wherein the cable feeding system is positioned above the loading end of the loading duct; and wherein the cable feeding system comprises:
a feeding element configured to guide cable into the loading duct;
a drive linkage coupling the feeding element to the drive system; and
a tensioning element configured to maintain tension on the cable; wherein the tensioning element is movable between an engaged position and a disengaged position.

7. (canceled)

8. (canceled)

9. The radiation effects testing system of claim 1, wherein a rail system comprising one or more guide tracks is positioned in the loading duct and the sample carrier is configured to travel along the rail system; wherein the one or more guide tracks extend outward from the loading end of the loading duct.

10. (canceled)

11. The radiation effects testing system of claim 9, wherein:
the sample loading system further comprises a drive system comprising a link mechanism coupled to a drive mechanism;
the link mechanism is positioned within at least one of the one or more guide tracks and coupled the sample carrier; and
the drive mechanism is configured to translate the link mechanism within the at least one guide track thereby translating the sample carrier along the loading duct.

12. The radiation effects testing system of claim 11, further comprising a cable retainer coupled to the link mechanism and positioned between the drive mechanism and the sample carrier.

13. The radiation effects testing system of claim 11, wherein the drive system further comprises:
a secondary link mechanism positioned within the secondary guide track and coupled to the sample carrier; and
a coupling member connecting the drive mechanism to the secondary link mechanism; wherein the drive mechanism is configured to simultaneously translate both the link mechanism and the secondary link mechanism through their respective guide tracks.

14. (canceled)

15. The radiation effects testing system of claim 13, wherein the coupling member comprises a drive plate positioned between the drive mechanism and both link mechanisms, and connecting arms extending from the drive plate to the secondary link mechanism.

16. The radiation effects testing system of claim 9, wherein the one or more guide tracks of the rail system comprise a primary guide track and a secondary guide track, wherein the primary guide track extends along a first inner wall of the loading duct and the secondary guide track extends along a second inner wall of the loading duct.

17. The radiation effects testing system of claim 16, wherein the sample carrier comprises a base connector coupled to the primary guide track and a roof connector coupled to the secondary guide track.

18. (canceled)

19. The radiation effects testing system of claim 1, wherein the sample loading system further comprises a duct plug removably positionable in the loading end of the loading duct and when the duct plug is positioned in the loading end of the loading duct, the duct plug blocks a neutron line of sight between the target chamber and the loading end of the loading duct.

20. The radiation effects testing system of claim 1, wherein:
the sample test housing and target chamber are each housed in a bunker comprising a bunker floor and one or more bunker walls;
water is positioned in the bunker forming a water pool; and
the sample test housing and the target chamber are positioned in the water pool.

21. The radiation effects testing system of claim 20, wherein the sample test housing and the target chamber are positioned in the water pool wholly below a water line of the water pool.

22. The radiation effects testing system of claim 20, wherein the loading end of the loading duct is positioned above a water line of the water pool.

23. The radiation effects testing system of claim 1, wherein the loading duct comprises a lowered sump area; and wherein the lowered sump area is positioned at an intersection of the descent segment and the approach segment.

24. (canceled)

25. The radiation effects testing system of claim 1, wherein the target chamber is positioned such that the sample test housing surrounds the target chamber.

26. The radiation effects testing system of claim 1, wherein the sample test housing further comprises a source receiving slot, and the target chamber is positioned in the source receiving slot of the sample test housing such that the sample test housing surrounds the target chamber.

27. The radiation effects testing system of claim 1, wherein:
the neutron generator further comprises a low-pressure chamber positioned along the beamline between the beam accelerator and the target chamber;
the target chamber houses tritium; and
the ion beam comprises a deuterium beam.

28.-59. (canceled)
